(19) United States
(12) Patent Application Publication
(10) Pub. No.: US 2012/0292880 A1
(43) Pub. Date: Nov. 22, 2012

(54) Children's Vehicle with a Shifting Mechanism

(75) Inventor: David M. Bapst, South Wales, NY (US)

(73) Assignee: MATTEL, INC., El Segundo, CA (US)

(21) Appl. No.: 13/421,177

(22) Filed: Mar. 15, 2012

Related U.S. Application Data
(60) Provisional application No. 61/453,268, filed on Mar. 16, 2011.

(51) Int. Cl. B62M 1/02; F16H 3/44

(52) U.S. Cl. 280/260; 475/300

(57) ABSTRACT

A wheeled vehicle with an adjustable gear arrangement is disclosed. The gear arrangement can be adjusted by a child riding the wheeled vehicle.

### CROSS-REFERENCE TO RELATED APPLICATIONS

This application claims the benefit of and priority under 35 U.S.C. 119(e) to U.S. Provisional Application No. 61/453,268, entitled “Children's Vehicle with a Shifting Mechanism”, filed Mar. 16, 2011, the disclosure of which is incorporated herein by reference in its entirety.

### FIELD OF THE INVENTION

The present invention relates to a children's vehicle, and in particular, to a children's vehicle with a shifting mechanism that enables a child to change the gearing of the vehicle.

### BACKGROUND OF THE INVENTION

Children enjoy riding vehicles, and in particular, toy vehicles. Some vehicles for children include pedals that are moved by a child to drive or propel the vehicle across a surface. Depending on the surface or terrain on which the toy vehicle is ridden, a child may have difficulty pedaling the toy vehicle.

Thus, there is a need for a vehicle that can be pedaled by a child over different types of surfaces and terrains. There is a need for a vehicle that has a gearing arrangement that is easily adjustable. Also, there is a need for a shifting mechanism for a children's vehicle that allows a child to change the gearing of the vehicle to facilitate the riding of the vehicle.

### SUMMARY OF THE INVENTION

In an embodiment of the present invention, a wheeled vehicle for a child includes a frame including a front axle and a rear portion, at least one rear wheel coupled to the rear portion, a front wheel coupled to the front axle and rotatable about an axis of the front axle, pedal cranks coupled to the front axle and rotatable about the axis of the front axle, a drive gear coupled to the front axle and rotatable about the axis of the front axle, the drive gear axially movable along the front axle between a first position and a second position, a first gear arrangement coupled to the front wheel, and a second gear arrangement coupled to the front wheel, wherein the pedal cranks are coupled to the front wheel via the first gear arrangement when the drive gear is in the first position, and the pedal cranks are coupled to the front wheel via the second gear arrangement when the drive gear is in the second position.

In one embodiment, the front wheel includes an outer surface configured for engaging a support surface and an inner toothed periphery, the first gear arrangement coupled to the inner toothed periphery.

In one embodiment, the wheeled vehicle is a tricycle including two rear wheels coupled to the rear portion.

In another embodiment of the present invention, a tricycle includes a frame including a front portion and a rear portion, a front fork coupled to the front portion and rotatable about a first axis, a front axle retained on the front fork and defining a second axis about which a front wheel is rotatably disposed, and a drive gear coupled to the front axle and rotatable about the second axis, the drive gear axially movable along the front axle between a first position directly engaging the front wheel, and a second position engaging the front wheel via a gearing arrangement.

In one embodiment, the first axis is substantially perpendicular to the second axis.

In one embodiment, the tricycle also includes a drive mechanism coupled to the front axle and rotatable about the second axis.

In addition, the drive mechanism is coupled to the front wheel via the gearing arrangement when the drive gear is in the second position. In another embodiment, the drive mechanism comprises pedal cranks.

In another embodiment of the present invention, a drive assembly for a wheeled vehicle includes an axle defining a first axis, a wheel coupled to the axle and rotatable about the first axis, pedal cranks coupled to the axle and rotatable about the first axis, a drive gear coupled to the axle and rotatable about the first axis, the drive gear axially movable along the axle between a first position and a second position, and at least one planetary gear coupled to the wheel, wherein the pedal cranks are directly driving the wheel when the drive gear is disposed in the first position, and the pedal cranks are driving the wheel via the at least one planetary gear when the drive gear is disposed in the second position.

In one embodiment, the wheel includes a pocket, the drive gear seated within the pocket when disposed in the first position.

In one embodiment, the wheel includes an outer surface configured for engaging a support surface and an inner toothed periphery, the at least one planetary gear engaging and rotatable along the inner toothed periphery.

### BRIEF DESCRIPTION OF THE DRAWINGS

FIG. 1 illustrates a perspective view of an embodiment of a wheeled vehicle according to the present invention.

FIG. 2 illustrates a cross-sectional side view of the wheeled vehicle illustrated in FIG. 1.

FIG. 3 illustrates an exploded front view of some of the components of the drive mechanism of the wheeled vehicle illustrated in FIG. 1.

FIG. 3A illustrates a perspective view of the output hub illustrated in FIG. 3.

FIG. 4 illustrates a front perspective view of the components illustrated in FIG. 3.

FIG. 5 illustrates a front cross-sectional view of the components illustrated in FIG. 3 in a low speed configuration.

FIG. 6 illustrates a front cross-sectional view of the components illustrated in FIG. 5 in a high speed configuration.

FIG. 7 illustrates a close-up perspective view of the front fork portion of the vehicle illustrated in FIG. 1 in a low speed configuration.

FIG. 8 illustrates a close-up perspective view of the front fork portion illustrated in FIG. 7 in a high speed configuration.

FIG. 9 illustrates a perspective view of the shift cable used with the vehicle illustrated in FIG. 1.

FIG. 10 illustrates a cross-sectional view of the shifter of the vehicle illustrated in FIG. 1.

FIG. 11 illustrates a perspective view of a gear mechanism of another embodiment of the present invention.

FIG. 12 illustrates another perspective view of the gear mechanism illustrated in FIG. 11.

FIG. 13 illustrates a side view of another embodiment of the gear mechanism illustrated in FIG. 11.

FIG. 14 illustrates a front perspective view of the gear mechanism illustrated in FIG. 13 with the driving gear in an offset position.

FIG. 15 illustrates some of the components of the gear mechanism illustrated in FIG. 13.

FIG. 16 illustrates a perspective view of another embodiment of a wheeled vehicle according to the present invention.

FIG. 17 illustrates a front perspective view of the front wheel and shifting mechanism of the wheeled vehicle illustrated in FIG. 16 in a first configuration.

FIG. 18 illustrates a front perspective view of the front wheel and shifting mechanism of the wheeled vehicle illustrated in FIG. 16 in a second configuration.

Like reference numerals have been used to identify like elements throughout this disclosure.

### DETAILED DESCRIPTION OF THE INVENTION

According to the present invention, a wheeled vehicle for a child includes a shifting mechanism that can be manipulated by a child to adjust the operation of the vehicle. The shifting mechanism is connected to a gear arrangement that can be adjusted to provide for different operational speeds of the vehicle and different levels of torque needed to move the vehicle. The gear arrangement of the vehicle is connected to a front wheel of the vehicle. Pedal cranks are coupled to the front wheel so that a child can engage and use the pedal cranks to turn the front wheel to move the vehicle.

In one embodiment, the gear arrangement has a first configuration in which each rotation of the pedal cranks by the child results in a direct rotation of the front wheel about its axis. This configuration is a low speed configuration of operation for the front wheel. In addition, the gear arrangement has a second configuration in which each rotation of the pedal cranks results in more than a single rotation of the front wheel about its axis. This configuration is a high speed configuration of operation for the front wheel. The high speed configuration of the gear arrangement results in more rotation of the front wheel per pedal crank rotation than the low speed configuration.

The configuration of the gear arrangement can be adjusted by the child while riding the wheeled vehicle. Accordingly, when a child encounters rough terrain, such as a lawn or uneven surface, the child can shift the wheeled vehicle into a low speed configuration to facilitate pedaling of the pedal cranks. When a child is riding on a flat or even terrain or surface, the child can ride with more speed by shifting the wheeled vehicle into its high speed configuration.

The terms “gear arrangement,” “gearing arrangement,” and “gear mechanism” are used interchangeably herein to refer to the gears that form the drive train between the pedal cranks and the front wheel of the vehicle.

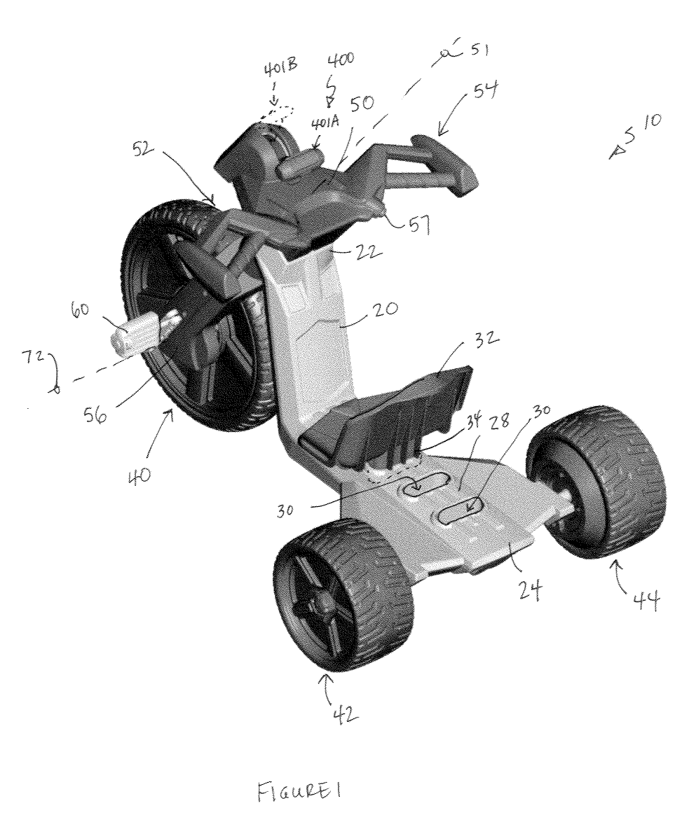

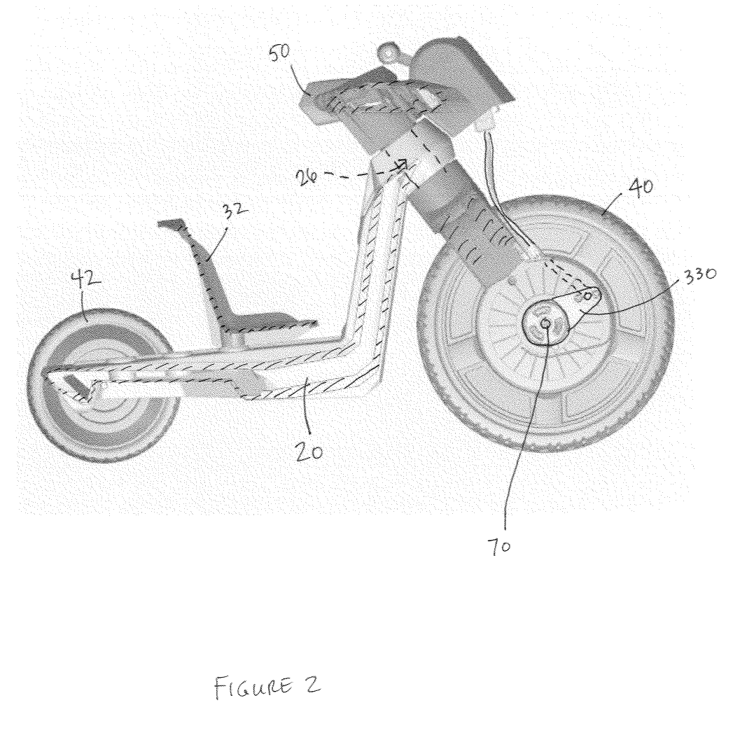

Referring to FIG. 1, a perspective view of a wheeled vehicle according to the present invention is illustrated. In this embodiment, the wheeled vehicle is a tricycle. The wheeled vehicle 10 includes a frame 20 with a front end or portion 22 and a rear end or portion 24. The frame 20 at the front end 22 includes an opening 26 (see FIG. 2). The frame 20 has an upper side 28 into which several spaced apart notches 30 are located. The wheeled vehicle 10 includes a seat portion 32 with a projection 34 that is insertable into one of the notches 30 to position the seat portion 32 on the frame 20. The projection 34 is retained in a notch 30 via friction. In other embodiments, the projection 34 is retained in the notch 30 using a connector, such as a screw. The adjustability of the seat portion 32 on the frame 20 allows different sized children to ride the vehicle 10.

The wheeled vehicle 10 includes a steerable front wheel 40 and a pair of rear wheels 42 and 44 coupled to the frame 20. The rear wheels 42 and 44 are rotatably coupled to the rear end 24 of the frame 20. The front wheel 40 is coupled to a handle 50 that extends through the opening 26 in the frame 20. The handle 50 is rotatably mounted to the frame 20 and movable about axis 51. The handle 50 can be used by the child to turn the front wheel 40 to steer the vehicle 10. In this embodiment, the handle 50 has two handle or grip portions 52 and 54 and a front or lower fork portion 56. A shifter 400 is provided on the handle 50 for adjustment of the operation of the vehicle 10 by a child. The shifter 400 includes a grip portion that can be moved to one of two different positions 401A and 401B. The handle 50 also contains an electronic system with several switches and a speaker that is configured to generate audible outputs. One switch is actuated by a child pressing button 57. Another switch is actuated when a child moves the shifter 400 to either position 401A or position 401B.

Coupled to and located on opposite sides of the fork portion 56 are pedal cranks 60 (only one is shown in FIG. 1) that can be used by the child to rotate the front wheel 40. The pedal cranks 60 are coupled to a front axle 70 that is rotatably mounted to the fork portion 56. The front wheel 40 is coupled to the front axle 70 and both rotate about an axis 72. The pedal cranks 60 are rotatable about the axis 72 as well. In one embodiment, axis 72 is substantially perpendicular to axis 51 about which the handle 50 can be moved.

The wheeled vehicle 10 includes a drive mechanism 100 that can be actuated by a user to rotate the front axle 70 and the front wheel 40 to move the vehicle 10. As described below, the drive mechanism 100 includes a gear arrangement that is coupled to the front axle 70 and to the pedal cranks 60 so that when the user pedals the pedal cranks 60, the front wheel 40 rotates.

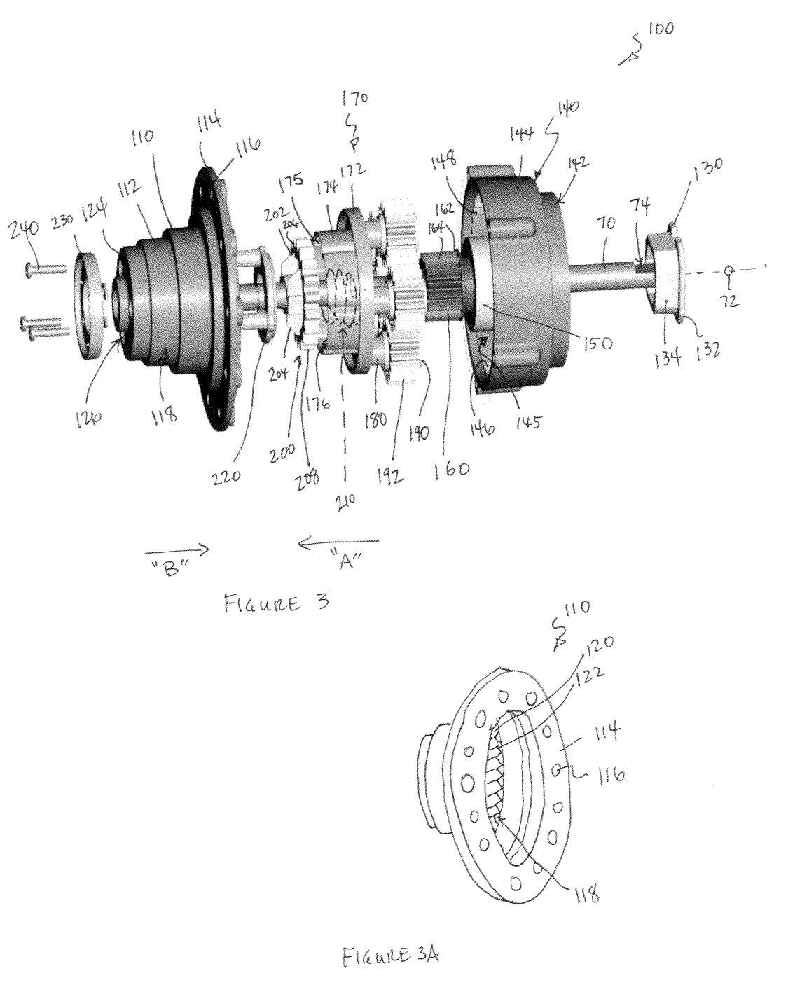

Referring to FIGS. 3, 3A, and 4, several views of different components of the drive mechanism 100 are illustrated. The drive mechanism 100 includes an output hub 110 that has a body portion 112 and a flange portion 114. The flange portion 114 includes several spaced apart openings 116 through which connectors (not shown), such as bolts or screws, can be inserted to couple the output hub 110 to the front wheel 40. In addition, some of the openings 116 are used to couple the output hub 110 to a gear ring 140, which is described in detail below. The body portion 112 has several portions with different diameters. One portion 118 has an inner surface 120 with a series of teeth 122 extending therealong, as shown in FIG. 3A. The body portion 112 also includes an end or end portion 124 through which openings 126 are formed. The teeth 122 of the output hub 110 form a first gear arrangement to which a drive gear can be coupled.

The front axle 70 has a notch 74 formed therein proximate to end 76. A thrust bearing 130 is slidable onto end 76 of the front axle 70. The thrust bearing 130 includes a plate 132 and a sleeve portion 134 that is configured to engage a corresponding opening in leg 58A of the front fork 56 to fix or ground the thrust bearing 130 to the front fork 56. The plate 132 includes an opening 136 (see FIG. 4) through which the front axle 70 is inserted. A washer 245 may be provided on the axle 70 as well.

The drive mechanism 100 includes a ring gear 140 that has a base portion 142 and a sleeve portion 144 defining a receptacle 145 and having an inner surface 146 that defines several teeth 148. A bearing 150 is centrally located within the receptacle 145 of the ring gear 140. The bearing 150 is pressed onto the ring gear 140 and maintains the ring gear 140 aligned on the front axle 70.

Also coupled to the front axle 70 is a sun gear 160 that has an outer surface 162 with several teeth 164 formed therein. The sun gear 160 is fixed or mounted so that it does not rotate relative to the front axle 70.

The drive mechanism 100 includes a carrier 170 that has a plate portion 172 and a sleeve portion 174 that defines a receptacle 175 into which several teeth 176 extend. The sleeve portion 174 extends from one surface of the plate portion 172 and extending from the other surface 178 of the plate portion 172 are several spaced apart posts 180. Rotatably mounted on each of the posts 180 is a planetary gear 190 that has an outer surface with several teeth 192 formed thereon. Each planetary gear 190 includes a central opening 194 that facilitates the mounting of the planetary gear 190 onto a post 180.

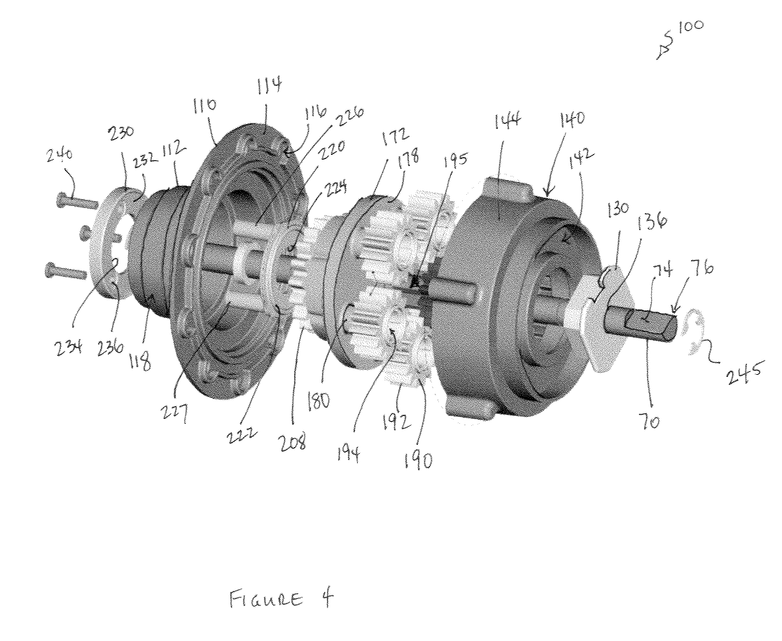

In this embodiment, there are six planetary gears 190 coupled to the plate portion 172 of the carrier 170. Each of the planetary gears 180 is independently rotatable. The planetary gears 190 are spaced apart from each other to define a central region 195 (see FIG. 4) therebetween into which the sun gear 160 can be inserted. When the sun gear 160 is positioned in the central region 195, the teeth 164 of the sun gear 160 engage the teeth 192 of each of the planetary gears 190. In addition, as shown in FIG. 5, the teeth 192 of the planetary gears 190 engage the teeth 148 formed on the inner surface of the ring gear 140. The gears coupled to the carrier 170 form a second or different gear arrangement to which the drive gear 200 can be coupled.

Referring back to FIG. 3, the drive mechanism 100 includes a drive gear 200 that is axially movable along the front axle 70 between different positions. The drive gear 200 includes a body 202 that has an engagement portion 204 on one side and an outer perimeter or surface 206 with several teeth 208. The body 202 has a diameter that permits the body 202 of the drive gear 200 to be slid into portion 118 of the output hub 110. As a result, the teeth 208 on the drive gear 200 can engage the teeth 122 formed on the inner surface of portion 118.

In this embodiment, the drive gear 200 is axially movable or slidable between the different gear arrangements with which it can be engaged. The drive gear 200 is biased along the direction of arrow “A” in FIG. 3 by a biasing member 210, such as a compression spring (shown in phantom), that is located within the receptacle 175 defined by sleeve portion 174 of the carrier 170. The biasing member 210 is positioned between and engages both the carrier 170 and the drive gear 200. Thus, the drive gear 200 is biased by member 210 so that its teeth 208 engage the teeth 122 of the output hub 110. In one embodiment, the biasing member 210 may be a two inch compression spring.

The drive mechanism 100 also includes a pusher 220 having a body 222 defining a central opening 224 and several posts 226 coupled to the body 222. Each of the posts 226 includes a distal end 227 that has an opening configured to receive a connector, as described below. The body 222 of the pusher 220 contacts the engagement portion 204 of the drive gear 200. As described below, the pusher 220 provides a force on the drive gear 200 along the direction of arrow “B” in FIG. 3 against the biasing force from member 210.

Each of the posts 226 of the pusher 220 is inserted into and through one of the openings 126 in the end portion 124 of the output hub 110 (see FIG. 3). A ring plate 230 is located on the outer side of the output hub 110 from the pusher 220. The ring plate 230 includes a body portion 232 that defines a central opening 234 with several mounting or coupling openings 236. Each of the openings 236 is aligned with a distal end 227 of a post 226 and a connector 240 is inserted through an opening 236 and into the post 226. Thus, when a force is applied to the ring plate 230, the force is transmitted to the pusher 220 coupled thereto because the posts 226 of the pusher 220 are allowed to slide back and forth through the openings 126 in the end 124 of the output hub 110.

As a result, the drive gear 200 is placeable in two different positions and the drive mechanism as a whole has two corresponding different configurations. The drive gear 200 can be placed into a first position in which the drive gear 200 is located within portion 118 of the output hub 110. In this position, the teeth 208 of the drive gear 200 are engaged with the teeth 122 on the output hub 110. As the drive gear 200 is rotated about axis 72, teeth 208 drive teeth 122 to cause the output hub 110 to rotate. In this configuration, there is a one-to-one effective gear ratio between the rotation of drive gear 200 and the rotation of the output hub 110. As the output hub 110 is directly coupled to the front wheel 40, in this configuration, for each rotation or revolution of drive gear 200, the output hub 110 and the front wheel 40 make a single rotation or revolution as well.

Drive gear 200 can be placed into a second position in which the drive gear 200 is spaced apart from the output hub 110. In this position, drive gear 200 is moved by the pusher 220 against the biasing force of member 210 and held inside the receptacle 175 of the carrier 170. When the gear 200 is in the receptacle 175, the teeth 208 of the drive gear 200 engage with the teeth 176 of the carrier 170. In one embodiment, the teeth 176 of the sleeve portion 174 may be formed as crimps in the material forming the sleeve portion 174. In this position, as drive gear 200 rotates, the engagement of the teeth 208 with the teeth 176 of the carrier 170 results in the rotation of the carrier 170 about the axis 72. As the sun gear 160 is fixed to the thrust bearing 130 and does not rotate, the rotation of the carrier 170 about the sun gear 160 results in each of the planetary gears 190 rotating relative to the carrier 170 due to the engagement of teeth 192 of the planetary gears 190 with the teeth 164 of the sun gear 160.

As the planetary gears 190 rotate, the engagement of the teeth 192 on the planetary gears 190 with the teeth 146 on the ring gear 140 causes the ring gear 140 to rotate. As shown in FIG. 5, the ring gear 140 is connected to the output hub 110 by several connectors 247 (only one of which is illustrated). Thus, rotation of the ring gear 140 causes rotation of the output hub 110 and the front wheel 40. In this configuration, the resulting rotation of the ring gear 140 drives the rotation of the front wheel 40 in a ratio that is different than a 1 to 1 gear ratio. In this embodiment, the gear ratio is 1.3 to 1. Thus, for each rotation of the drive gear 200, the front wheel 40 will rotate more than a single rotation (1.3 rotations in the illustrated embodiment). In other words, in an implementation in which the front wheel 40 has a 14 inch diameter, the gear ratio will result in the front wheel 40 having an effective diameter of 18.2 inches.

Referring to FIGS. 5 and 6, the different configurations of the drive mechanism 100 are illustrated. As shown, most of the components of the drive mechanism 100 are located between the legs 58A and 58B of the front fork 56. In FIG. 5, the drive mechanism 100 is illustrated in a first configuration 102. In this configuration 102, the drive gear 200 is in its low speed position in which the drive gear 200 is located in portion 118 of the output hub 110. The drive gear 200 is biased along the direction of arrow “C” by the biasing member 210 (not shown in this figure). Referring to FIG. 5, the posts 226 of the pusher 220 are illustrated as extending outwardly through the openings 126 in the end 124 of the output hub 110. As discussed above, the teeth 208 of the drive gear 200 engage the teeth 122 of the output hub 110. As the drive gear 200 rotates, the output hub 110 directly rotates.

In FIG. 6, the drive mechanism 100 is illustrated in a second configuration 104. In this configuration, the drive gear 200 is in its high or higher speed position in which the drive gear 200 is not engaged directly with the output hub 110. To move from the position illustrated in FIG. 5 to the position illustrated in FIG. 6, the drive gear 200 is moved along the direction of arrow “D” by the pusher 220. Referring to FIG. 6, the posts 226 of the pusher 220 have been moved inwardly and into the output hub 110 through openings 126. This movement causes the drive gear 200 to move into the receptacle 175 so that the teeth 208 engage the teeth 176 of the carrier 170.

Referring to FIGS. 5 and 6, the movement of the pusher 220 is illustrated. The drive mechanism 100 includes a cam mechanism 300 that has two cam members 310 and 320. In this embodiment, the cam member 310 is fixed to the leg portion 58B of the front fork 56, such as via bearing 135 that is coupled to the leg portion 58B. Cam member 320 is in engagement with cam member 310 and moves between position 321A in FIG. 5 corresponding to configuration 302 of the cam mechanism 300 and position 321B in FIG. 6 corresponding to configuration 304 of the cam mechanism 300.

As shown, cam member 310 has a body 312 with an outer member 314 that extends around the perimeter of the body 312. The body 312 includes a central opening configured to receive the axle 70 and a cam surface 316 that is formed in a tapered, helical configuration about the central opening. Cam member 320 includes a body 322 with an outer member 324 that extends around the perimeter of the body 322. The body 322 of cam member 320 includes a central opening configured to receive the axle 70 and a cam surface 326 that is configured to engage the cam surface 316 of cam member 310. As cam member 320 rotates relative to cam member 310, cam surface 326 travels along cam surface 316 of cam member 310, thereby moving cam member 320 along the direction of arrow “D” in FIG. 6. In this embodiment, the ring plate 230 engages the cam member 320. As the cam member 320 moves along the direction of arrow “D,” an engagement surface 328 of cam member 320 moves the ring plate 230 and as a result, the pusher 220.

Referring back to FIG. 2, cam member 320 also includes a lobe 330 that facilitates the rotation of cam member 320, as described below. The lobe 330 has a connector 332 that facilitates the coupling of a cable or moving element to cam member 320.

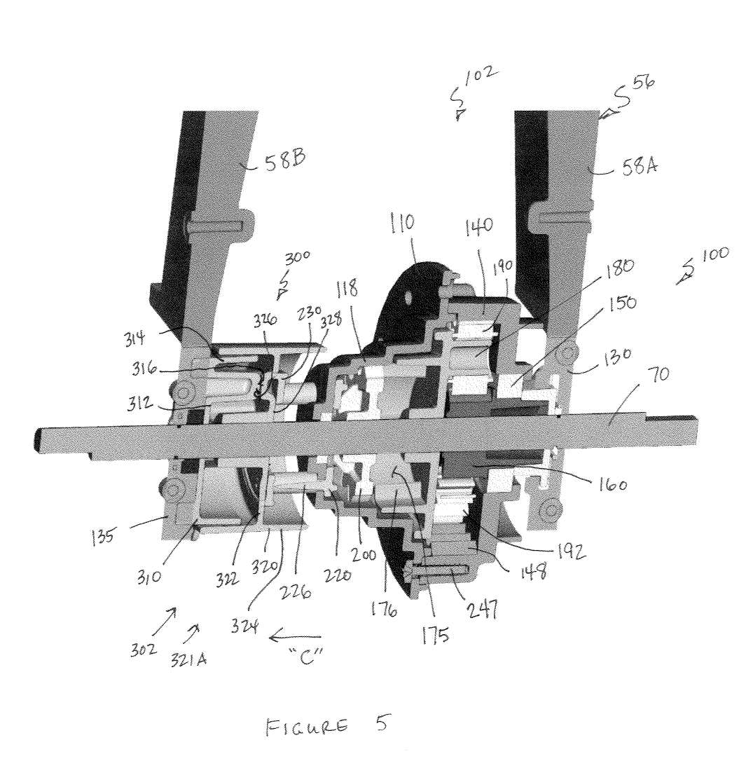

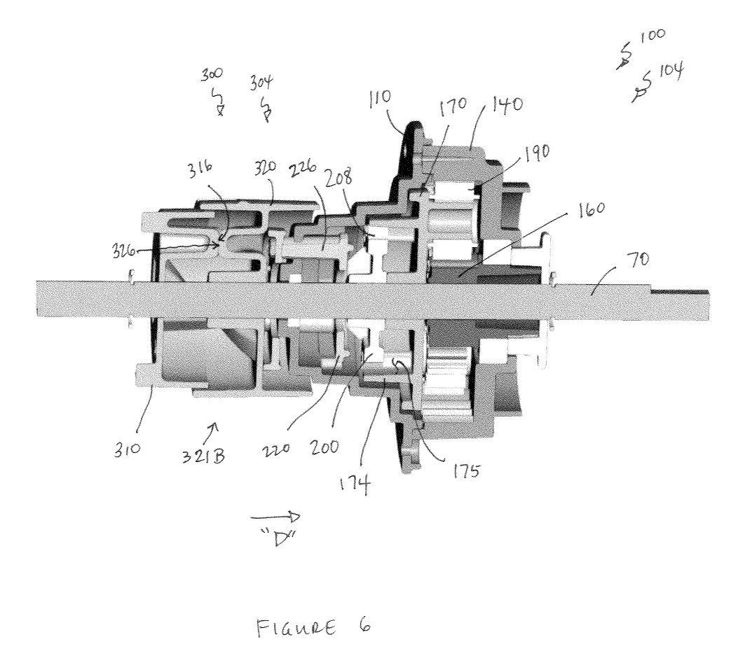

Referring to FIGS. 7 and 8, the movement of the cam member 320 is illustrated. In FIG. 7, the cam member 320 is in a lowered position 321A relative to cam member 310 with the lobe 330 in a lowered position. When the cam member 320 is in position 321A, drive gear 200 is directly engaged with the teeth 122 of the output hub 110. As the lobe 330 and connector 332 are moved along the direction of arrow “E” (see FIG. 8), cam member 320 moves along the cam surface 316 of cam member 310. As a result, cam member 320 moves along the direction of arrow “G” to another position 321B (See FIG. 8). In this position 321B, drive gear 200 is directly engaged with the teeth of the carrier 170. To move the cam member 320 along the direction of arrow “H” back to its initial position 321A (by allowing the biasing member 210 to bias the drive gear 200 outwardly), the lobe 330 is moved along the direction of arrow “F.”

As shown in FIG. 8, in this embodiment, the connector 332 of the lobe 330 of cam member 320 includes mounting posts 334 and 336, each of which includes an opening 335 and 337, respectively. The connector 332 also includes a stand 338 located between the posts 334 and 336.

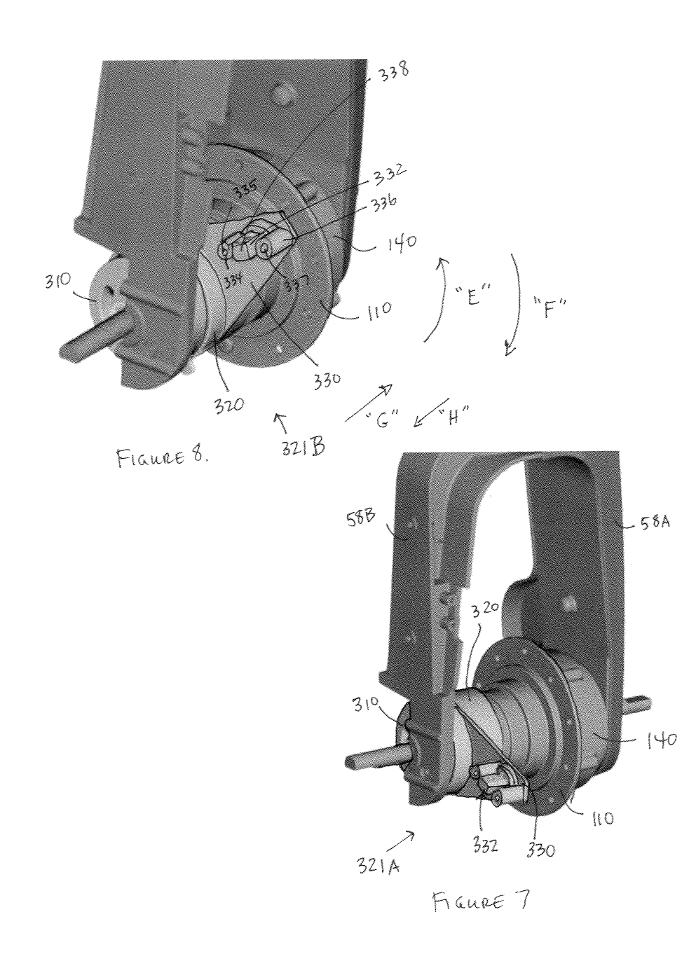

Referring to FIG. 9, an embodiment of an actuator according to the present invention is illustrated. In this embodiment, the actuator 350 includes a sleeve portion 352 with opposite ends 354 and 356. The sleeve portion 352 includes an alignment guide or member 360 that is coupleable to a housing 410 (described relative to FIG. 10 below). The sleeve portion 352 also includes at its opposite end a connector 370 that can be connected to connector 332 on cam member 320. As shown, connector 370 includes a plate 371 with mounting posts 372 and 374 with corresponding openings 376 and 378. A connector, such as a screw or bolt, can be inserted into opening 376 of post 372 and opening 335 of post 334. Similarly, another connector can be inserted into opening 378 of post 374 and opening 337 of post 336. In addition to the sleeve portion 352, the actuator 350 includes a cable or wire 358 that has end connectors 362 and 380 at its opposite ends and a spring 390. When the actuator 350 is pulled or pushed, cam member 320 moves in the corresponding direction due to the connection between actuator 350 and cam member 320. Note that although a cable or wire 358 is illustrated, a more rigid device such as a rod may be utilized.

Referring to FIG. 10, a cross-sectional perspective view of a shifter 400 of the wheeled vehicle 10 is illustrated. The shifter 400 includes a housing 410 that is located in the handle 50. The housing 410 includes a notch 412 formed therein through which a shaft 421 extends. The shaft 421 is part of rotator 420 and includes a grip 422 at its distal end. The grip 422 extends from the handle 50 and can be grasped by a child to move the rotator 420 about its central opening 428. A post or similar member can be inserted through the central opening 428 to rotatably mount the rotator 420 to the housing 410. As a result, the rotator 420 can be moved back and forth along the directions of arrow “I” to its positions 401A and 401B shown in FIG. 1.

Referring back to FIG. 10, in this embodiment, the rotator 420 has a lower end with a wall 430 that defines a notch or recess 432. The notch 432 has two portions and each of the portions has an abutment 434 at its end. The shifter 400 includes a lock member 440 that is biased into engagement with the rotator 420 by a biasing member 450 that is mounted on post 444. The biasing member 450 has opposite ends 452 and 454 that are coupled to the lock member 440 and the housing 410, respectively. The lock member 440 includes a projection 442 that is configured to engage the notch 432 in the rotator 420 to maintain the rotator 420 in a particular position.

The rotator 420 includes a wall 424 defining a receptacle or recess 426 into which the end connector 362 of actuator 350 is placed. As the rotator 420 is moved by a child, the rotator 420 either pushes or pulls the end connector 362 of the actuator 350 in the corresponding direction. This movement results in the actuator 350 moving the lobe 330 of cam member 320 and the cam member 320 as well. As described above, the movement of the cam member 320 causes the drive gear 200 to move between its different shifting positions.

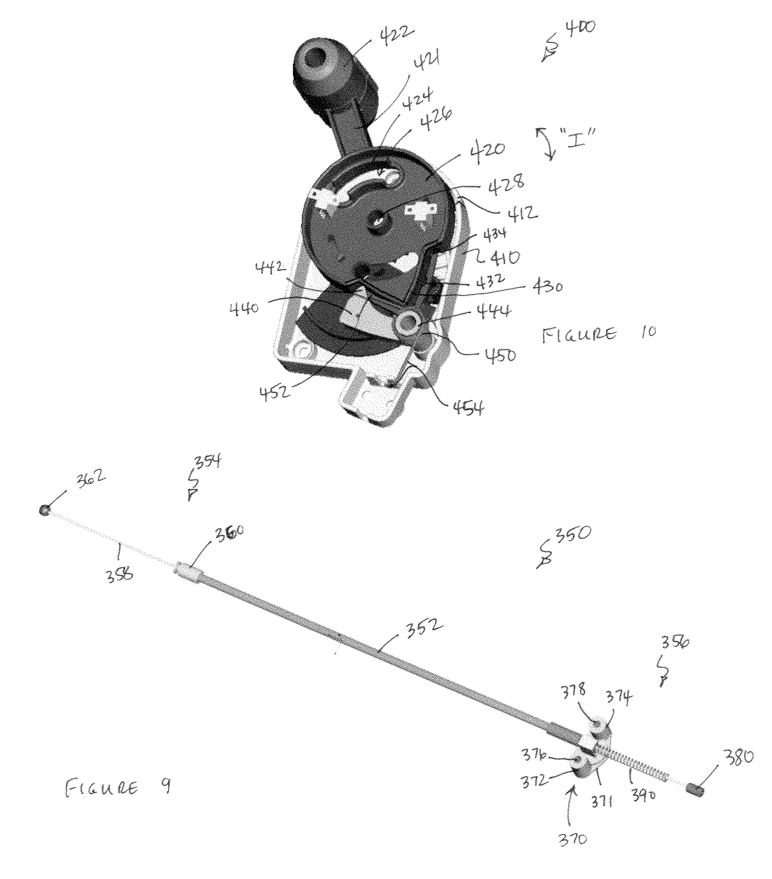

Referring to FIGS. 11 and 12, another embodiment of a gear arrangement according to the invention is illustrated. In this embodiment, the gear arrangement 500 includes a ring gear 510 with teeth 512 located around an inner perimeter. The arrangement 500 also includes a carrier 520 that has three sets of planetary gears 530 with teeth 532. Each set of planetary gears 530 includes a gear 534 in engagement with the teeth 512 of the ring gear 510 and a gear 536 in engagement with the teeth 542 of a driving gear 540. The driving gear 540 includes a central opening 544 that is configured to receive a mating portion 552 of an axle 550 extending therethrough. In this configuration, as the driving gear 540 and the axle 550 rotate about axis 554, the planetary gears 530 drive the ring gear 510, which is coupled to an output hub and a front wheel of a vehicle. In this embodiment, when the drive or driving gear 540 is engaged with the planetary gears 530, there is a 2.2 to 1 gear reduction. Referring FIG. 12, the driving gear 540 has been moved along the mating portion 552 of axle 550 and into direct engagement with the output housing or hub 516, which results in a 1 to 1 direct drive arrangement.

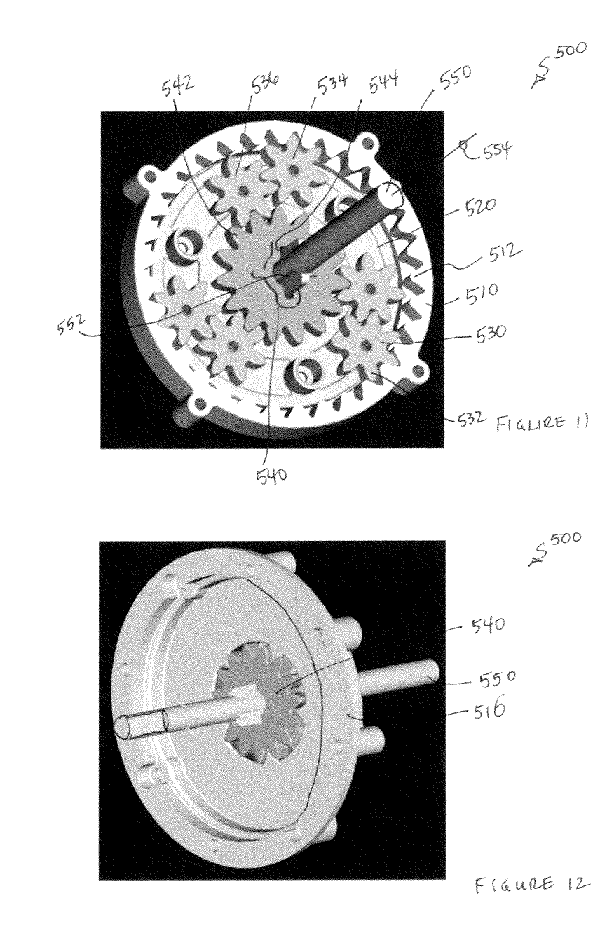

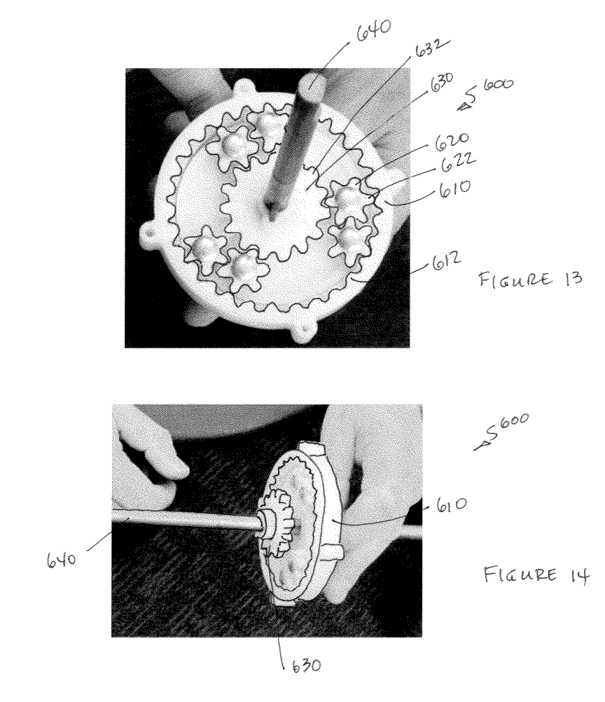

An embodiment of a similar gear arrangement is illustrated in FIGS. 13-15. In this embodiment, the gear arrangement 600 includes a ring gear 610 with inner teeth 612 and several planetary gears 620 with teeth 622. A driving gear 630 is mounted on axle 640 and keyed thereto so that rotation of the axle 640 results in rotation of the driving gear 630 and the engagement of teeth 632 with the teeth 622 of the corresponding gears in the sets of planetary gears 630. As shown in FIG. 15, an output hub 650 can be coupled to the ring gear 610. The output hub 650 includes a sleeve 652 with teeth 654 that can be engaged by the teeth 632 of the driving gear 630 to rotate the output hub 650 directly. Note that the driving gear 630 can be slid along axle 640 into either engagement position.

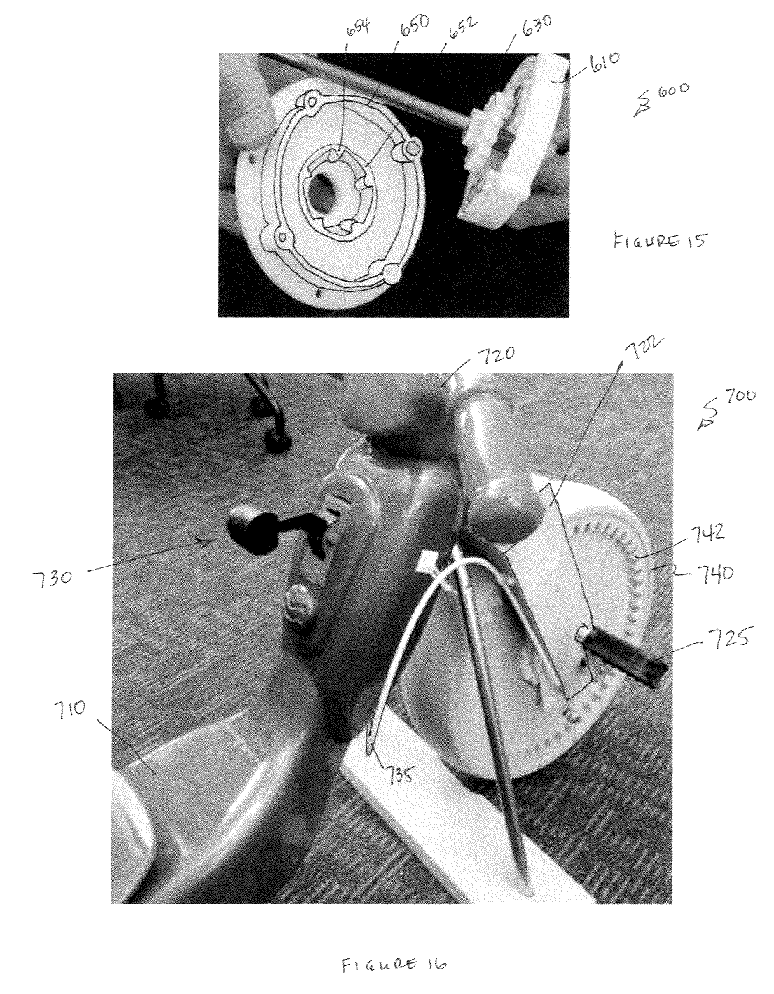

Referring to FIGS. 16-18, another embodiment of a wheeled vehicle according to the present invention is illustrated. In this embodiment, the wheeled vehicle 700 includes a frame 710 and a handle 720 rotatably mounted to the frame 710. The handle 720 is connected to a front fork 722 that supports a front wheel 740 and a pair of pedal cranks 725. The frame 710 includes a shifter 730 that is configured to enable a child to change the gearing arrangement of the vehicle 700. The shifter 730 is connected to a cable 735 that changes the gear arrangement to achieve different speeds of rotation of the front wheel 740.

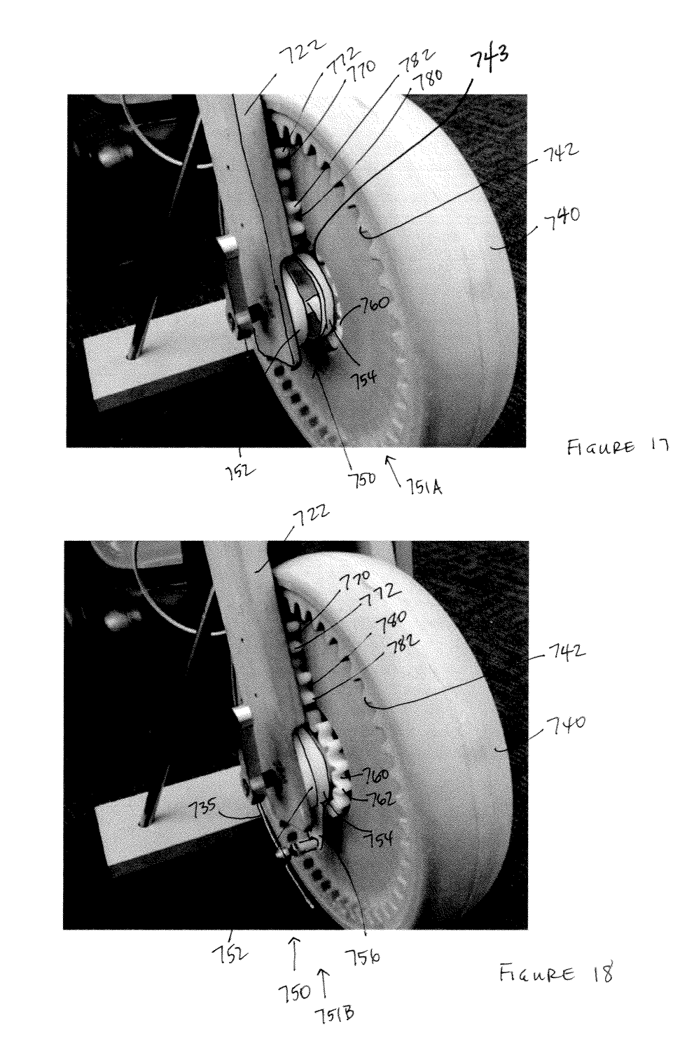

In this embodiment, the front wheel 740 includes a set of teeth 742 along an inner edge. While the teeth 742 are illustrated as being integrally molded with the front wheel 740, in different embodiments, the teeth 742 can be formed separately and subsequently coupled to the front wheel 740. Referring to FIGS. 17 and 18, a pair of gears 770 and 780 is rotatably mounted to an inner surface of front fork 722. The teeth 772 and 782 of the gears 770 and 780 are engaged with each other. In addition, the teeth 772 of gear 770 are in engagement with the teeth 742 of front wheel 740.

Referring to FIG. 17, a sliding or driving gear 760 is mounted for movement between multiple positions. In one position, the gear 760 is located within a central opening or pocket 743 in the front wheel 740 and the teeth 762 of the driving gear 760 engage the teeth of an internal gearing system in the front wheel 740. The pocket can be referred to alternatively as a receptacle or chamber, and is formed by a wall or surface that defines an area configured to receive the gear 760. In this configuration, the gear ratio of the rotation of the front wheel 740 to the rotation of the driving gear 760 is approximately 1 to 1. As shown in FIG. 17, a cam mechanism 750 includes a fixed cam member 752 and a movable cam member 754. The movable cam member 754 is moved inwardly in this configuration, thereby pushing the driving gear 760 into the opening of the front wheel 740.

In the configuration illustrated in FIG. 17, the teeth 782 of gear 780 are not in engagement with anything other than teeth 772 of gear 770. As a result, the gears 770 and 780 are not used to drive the front wheel 740 and only freely spin while front wheel 740 rotates.

Referring to FIG. 18, the movable cam member 754 includes a lobe 756 that is connected to actuator 735. The lobe 756 has been moved from its position 751A in FIG. 17 to its position 751B in FIG. 18, which results in movable cam member 754 being proximate to fixed cam member 752. When the movable cam member 754 is moved to this position, gear 760 is moved to an outer position in which the teeth 762 of the driving gear 760 engage the teeth 782 of gear 780. In this configuration, rotation of gear 760 causes gears 770 and 780 to rotate and drive front wheel 740 via teeth 742 along the inner toothed periphery. The overall rotation of front wheel 740 in this configuration is much slower per rotation or revolution of driving gear 760 than in the configuration illustrated in FIG. 17.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, terms such as “first,” “second,” “third,” etc., merely identify one of a number of portions, components and/or points of reference as disclosed herein, and do not limit the present invention to any particular configuration or orientation. In addition, the term “infant support structure” and “support structure” may be used interchangeably herein to refer to a structure that can be configured to hold and support a child or infant. The terms “infant” and “child” may be used interchangeably herein.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. A wheeled vehicle for a child, comprising:
a frame including a front axle and a rear portion;
at least one rear wheel coupled to the rear portion;
a front wheel coupled to the front axle and rotatable about an axis of the front axle;
pedal cranks coupled to the front axle and rotatable about the axis of the front axle;
a drive gear coupled to the front axle and rotatable about the axis of the front axle, the drive gear axially movable along the front axle between a first position and a second position;
a first gear arrangement coupled to the front wheel; and
a second gear arrangement coupled to the front wheel, wherein the pedal cranks are coupled to the front wheel via the first gear arrangement when the drive gear is in the first position, and the pedal cranks are coupled to the front wheel via the second gear arrangement when the drive gear is in the second position.

2. The wheeled vehicle of claim 1, wherein the front wheel includes an outer surface configured for engaging a support surface and an inner toothed periphery, the first gear arrangement coupled to the inner toothed periphery.

3. The wheeled vehicle of claim 1, wherein the wheeled vehicle is a tricycle including two rear wheels coupled to the rear portion.

4. The wheeled vehicle of claim 1, wherein the axis of the front axle is a first axis, and the frame further comprises a front fork coupled to the frame and rotatable about a second axis.

5. The wheeled vehicle of claim 4, wherein the front axle and front wheel are coupled to the front fork of the frame.

6. The wheeled vehicle of claim 4, wherein the first axis is substantially perpendicular to the second axis.

7. The wheeled vehicle of claim 1, further comprising a shifter disposed on the frame, the shifter being coupled to the drive gear and configured to axially move the drive gear between the first position and the second position.

8. The wheeled vehicle of claim 1, further comprising a seat disposed on the frame between the front axle and the rear portion.

9. A tricycle, comprising:
a frame including a front portion and a rear portion;
a front fork coupled to the front portion and rotatable about a first axis;
a front axle retained on the front fork and defining a second axis about which a front wheel is rotatably disposed;
a rear axle coupled to the rear portion and defining a third axis;
pedal cranks coupled to the front axle and rotatable about the second axis; and
a drive gear coupled to the front axle and rotatable about the second axis, the drive gear axially movable along the front axle between a first position directly engaging the front wheel, and a second position engaging the front wheel via a gearing arrangement.

10. The tricycle of claim 9, wherein the first axis is substantially perpendicular to the second axis.

11. The tricycle of claim 9, further comprising a drive mechanism coupled to the front axle and rotatable about the second axis.

12. The tricycle of claim 11, wherein the drive mechanism is coupled to the front wheel via the gearing arrangement when the drive gear is in the second position.

13. The tricycle of claim 9, wherein the front wheel includes an outer surface configured for engaging a support surface and an inner toothed periphery, the drive gear coupled to the inner toothed periphery when in the first position.

14. The tricycle of claim 9, further comprising two rear wheels coupled to the rear axle.

15. The tricycle of claim 9, further comprising a shifter disposed on the frame, the shifter being coupled to the drive gear and configured to axially move the drive gear between the first position and the second position.

16. The tricycle of claim 15, wherein the shifter includes a lever with a first orientation and a second orientation, the shifter in the first orientation moves the drive gear into the first position and the shifter in the second orientation moves the drive gear into the second position.

17. The tricycle of claim 9, further comprising a seat coupled on the frame between the front and rear portions.

18. A drive assembly for a wheeled vehicle, comprising:
an axle defining a first axis;
a wheel coupled to the axle and rotatable about the first axis;
pedal cranks coupled to the axle and rotatable about the first axis;
a drive gear coupled to the axle and rotatable about the first axis, the drive gear axially movable along the axle between a first position and a second position;
at least one planetary gear coupled to the wheel, wherein the pedal cranks are directly driving the wheel when the drive gear is disposed in the first position, and the pedal cranks are driving the wheel via the at least one planetary gear when the drive gear is disposed in the second position.

19. The drive assembly of claim 18, wherein the wheel defines a receptacle, the drive gear seated within the receptacle when disposed in the first position.

20. The drive assembly of claim 18, wherein the wheel includes an outer surface configured for engaging a support surface and an inner toothed periphery, the at least one planetary gear engaging and rotatable along the inner toothed periphery.
